(19) United States
(12) Patent Application Publication
(10) Pub. No.: US 2026/0081309 A1
(43) Pub. Date: Mar. 19, 2026

(54) ENERGY STORAGE APPARATUS AND METHOD FOR MANUFACTURING THE SAME

(71) Applicant: GS Yuasa International Ltd., Kyoto-shi (JP)

(72) Inventor: Nobuaki SHIBATA, Kyoto-shi (JP)

(21) Appl. No.: 19/401,653

(22) Filed: Nov. 26, 2025

Related U.S. Application Data
(63) Continuation of application No. PCT/JP2024/019339, filed on May 27, 2024.

(30) Foreign Application Priority Data
Jun. 8, 2023 (JP) 2023-094587

(51) Int. Cl. H01M 50/503; H01M 50/211

(52) U.S. Cl. CPC H01M 50/503; H01M 50/211

(57) ABSTRACT

An energy storage apparatus includes an energy storage device, a bus bar that is electrically connected to the energy storage device, a holder to hold the bus bar in a state where a portion of the bus bar is fixed, and a conductor that is joined to the bus bar, in which the bus bar includes a protrusion that protrudes with such a posture that the bus bar faces one surface of the holder and is joined to the conductor, the protrusion includes a facing surface that faces the one surface, and an interval between the one surface and the facing surface widens toward a predetermined direction.

### CROSS REFERENCE TO RELATED APPLICATIONS

This application claims the benefit of priority to Japanese Patent Application No. 2023-094587 filed on Jun. 8, 2023 and is a Continuation Application of PCT Application No. PCT/JP2024/019339 filed on May 27, 2024. The entire contents of each application are hereby incorporated herein by reference.

### BACKGROUND OF THE INVENTION

### 1. Field of the Invention

The present invention relates to energy storage apparatuses and methods for manufacturing the same.

### 2. Description of the Related Art

Conventionally, an assembled battery is provided with a case that houses a plurality of battery cells. An outer surface of the case is connected with bus bars that electrically connect to the battery cells, and fuses (see, for example, JP-A-2020-123517).

### SUMMARY OF THE INVENTION

In recent years, although there is a case where a holder to hold bus bars and the bus bars are integrated by insert molding or the like, it is required to improve manufacturability in such a case.

Example embodiments of the present invention provide energy storage apparatuses and the like that improve manufacturability.

An energy storage apparatus according to an example embodiment of the present invention includes an energy storage device, a bus bar that is electrically connected to the energy storage device, a holder to hold the bus bar in a state where a portion of the bus bar is fixed, and a conductor that is joined to the bus bar, in which the bus bar includes a protrusion that protrudes with such a posture that the bus bar faces one surface of the holder and is joined to the conductor, the protrusion includes a facing surface that faces the one surface, and an interval between the one surface and the facing surface widens toward a predetermined direction.

A method for manufacturing an energy storage apparatus according to another example embodiment of the present invention is a method for manufacturing an energy storage apparatus including an energy storage device, a bus bar that is electrically connected to the energy storage device, and a holder to hold the bus bar in a state where a portion of the bus bar is fixed, the method including integrating the portion of the bus bar and the holder by insert molding with such a posture that a portion other than the portion of the bus bar is a protrusion that protrudes from the holder, and removing a mold in an interval toward a predetermined direction, the interval being between one surface of the holder and a facing surface of the protrusion facing the one surface, and widening toward the predetermined direction.

According to example embodiments of the present invention, it is possible to provide energy storage apparatuses that improve manufacturability.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating an external appearance of an energy storage apparatus according to an example embodiment of the present invention.

FIG. 2 is an exploded perspective view illustrating respective components in a case where an energy storage apparatus according to an example embodiment is disassembled.

FIG. 3 is a perspective view illustrating a second holder according to an example embodiment of the present invention.

FIG. 4 is a perspective view illustrating a connection structure between an other end portion of a bus bar and a fuse according to an example embodiment of the present invention.

FIG. 5 is a partial cross-sectional view of a second support region according to an example embodiment of the present invention.

FIG. 6 is a cross-sectional view illustrating one process of a method for manufacturing an energy storage apparatus according to an example embodiment of the present invention.

FIG. 7 is a cross-sectional view illustrating one process of a method for manufacturing an energy storage apparatus according to an example embodiment of the present invention.

FIG. 8 is a cross-sectional view illustrating one process of a method for manufacturing an energy storage apparatus according to an example embodiment of the present invention.

### DETAILED DESCRIPTION OF THE EXAMPLE EMBODIMENTS

(1) An energy storage apparatus according to an example embodiment of the present invention includes an energy storage device, a bus bar that is electrically connected to the energy storage device, a holder to hold the bus bar in a state where a portion of the bus bar is fixed, and a conductor that is joined to the bus bar, in which the bus bar includes a protrusion that protrudes with such a posture that the bus bar faces one surface of the holder and is joined to the conductor, the protrusion includes a facing surface that faces the one surface, and an interval between the one surface and the facing surface widens toward a predetermined direction.

In the energy storage apparatus described in above (1), a mold is in the interval between the one surface of the holder and the facing surface of the protrusion at a time of insert molding of the holder and the bus bar. The interval between the one surface of the holder and the facing surface of the protrusion widens toward the predetermined direction, so that it is possible to smoothly remove the mold when the mold is removed in the predetermined direction. Consequently, it is possible to reduce or prevent damages on the holder and the protrusion, and the joining property of the protrusion and the conductor improves. That is, it is possible to enhance manufacturability and reliability of the energy storage apparatus.

(2) In the energy storage apparatus described in above (1), the predetermined direction may be a protruding direction of the protrusion.

According to the energy storage apparatus described in above (2), it is also possible to remove the mold by setting as a predetermined direction a direction intersecting the protruding direction of the protrusion at a time of manufacturing. However, in this case, if the bus bar is configured such that the interval between the one surface and the facing surface widens toward the predetermined direction (a direction intersecting the protruding direction), the bus bar becomes complicated. By setting the protruding direction of the protrusion as the predetermined direction as in the present example embodiment, it is possible to prevent the bus bar from becoming complicated.

(3) In the energy storage apparatus in above (1) or (2), the protrusion may entirely incline toward the predetermined direction.

According to the energy storage apparatus described in above (3), the entire protrusion inclines toward the predetermined direction, so that it is possible to widen the interval between the one surface of the holder and the facing surface of the protrusion toward the predetermined direction with a simple structure.

(4) In the energy storage apparatus described in any one of above (1) to (3), an angle between the facing surface and the one surface may be about 0.5 degrees or more.

According to the energy storage apparatus described in above (4), the angle between the facing surface and the one surface is a general draft angle (about 0.5 degrees) or more, so that it is possible to smoothly remove the mold.

(5) In the energy storage apparatus described in any one of above (1) to (4), a thickness of the conductor may be smaller than a thickness of the protrusion.

According to the energy storage apparatus described in above (5), the thickness of the conductor is smaller than the thickness of the protrusion, so that it is possible to make the conductor more deformable than the protrusion. Hence, even if the protrusion inclines, it is possible to deform the conductor according to this inclination. Consequently, it is possible to enhance the joining property of the protrusion and the conductor.

(6) A method for manufacturing an energy storage apparatus according to another example embodiment of the present invention is a method for manufacturing an energy storage apparatus including an energy storage device, a bus bar that is electrically connected to the energy storage device, and a holder to hold the bus bar in a state where a portion of the bus bar is fixed, the method including integrating the portion of the bus bar and the holder by insert molding with such a posture that a portion other than the portion of the bus bar is a protrusion that protrudes from the holder, and removing a mold in an interval toward a predetermined direction, the interval being between one surface of the holder and a facing surface of the protrusion facing the one surface, and widening toward the predetermined direction.

According to the method for manufacturing the energy storage apparatus described in above (6), a mold is in the interval between the one surface of the holder and the facing surface of the protrusion at a time of insert molding of the holder and the bus bar. The interval between the one surface of the holder and the facing surface of the protrusion widens toward the predetermined direction, so that it is possible to smoothly remove the mold when the mold is removed in the predetermined direction. Consequently, it is possible to enhance manufacturability of the energy storage apparatus.

Hereinafter, an energy storage apparatus according to example embodiments (including modifications thereof) of the present invention will be described with reference to the drawings. Note that the example embodiments and modifications thereof described below describes comprehensive or specific examples. Numerical values, shapes, materials, components, arrangement positions and connection modes of the components, and the like described in the following example embodiments and modifications thereof are merely examples, and are not intended to limit the present invention. In each drawing, dimensions and the like are not strictly illustrated. In the drawings, the same or similar components are assigned the same reference numerals. The names of the elements (components) according to the present example embodiments are names in the present example embodiments, and may be different from the names of the elements (components) in the background art.

In the following description and drawings, an alignment direction of a main body and an outer lid in an outer case of the energy storage apparatus or an alignment direction of a plurality of energy storage devices included in the energy storage apparatus is defined as an X axis direction. A protruding direction of each lead terminal of the energy storage device is defined as a Y axis direction. An alignment direction or an upper/lower direction of a pair of lead terminals included in the energy storage device is defined as a Z axis direction. These X axis direction, Y axis direction, and Z axis direction are directions intersecting (in the following example embodiment, orthogonal to) each other. Note that, although the Z axis direction may not be the upper/lower direction depending on a usage mode, the Z axis direction will be described below as the upper/lower direction for convenience of description. In the following description, for example, an X axis positive direction indicates an arrow direction side of an X axis, and an X axis negative direction indicates a side opposite to the X axis positive direction. The same also applies to the Y axis direction and the Z axis direction. Furthermore, there is also a case where expressions indicating relative directions or postures such as parallel do not strictly indicate the direction or the posture. For example, a sentence “two directions are orthogonal to each other” not only means that the two directions are completely orthogonal to each other, but also means that the two directions are substantially orthogonal to each other, that is, include a difference of, for example, approximately several percent. In the following description, an expression “insulation” means “electrical insulation”.

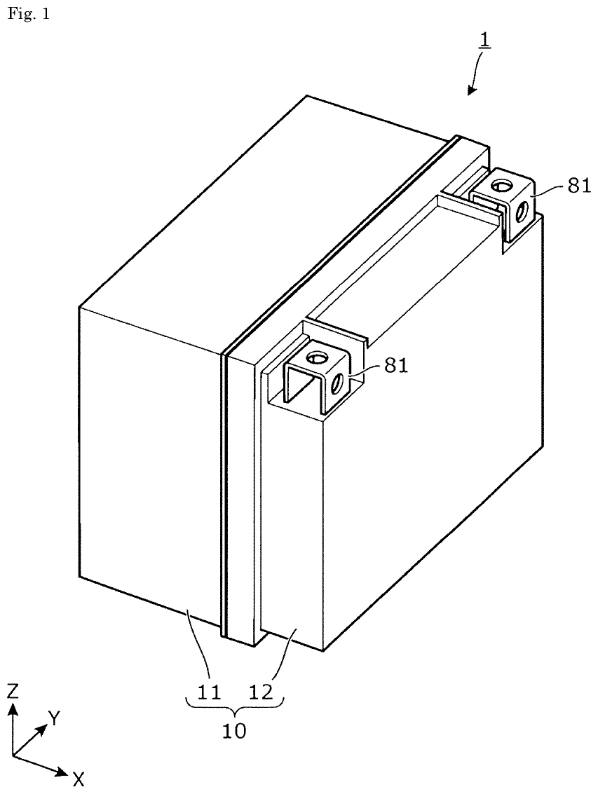

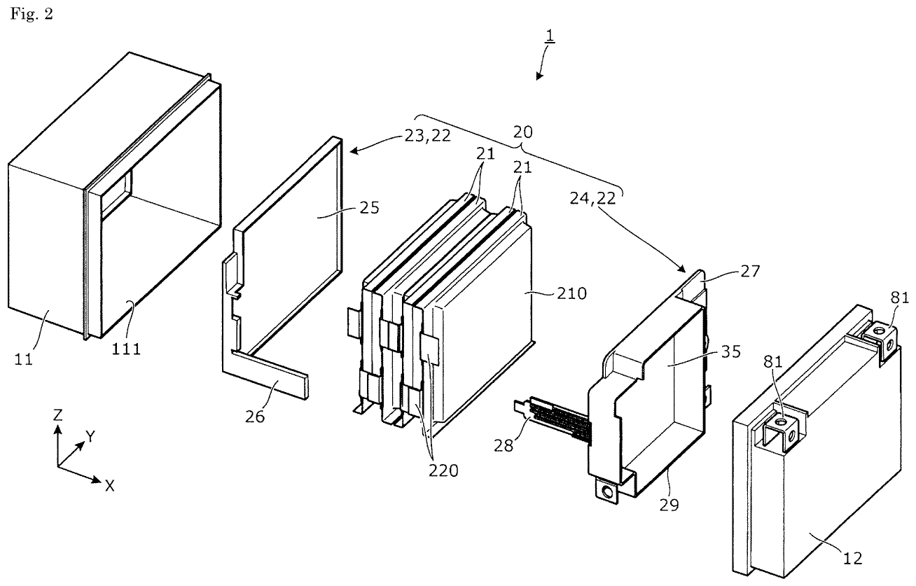

First, an energy storage apparatus 1 according to an example embodiment will be generally described with reference to FIGS. 1 and 2. FIG. 1 is a perspective view illustrating the external appearance of the energy storage apparatus 1 according to the present example embodiment. FIG. 2 is an exploded perspective view illustrating respective components in a case where the energy storage apparatus 1 according to the present example embodiment is disassembled.

The energy storage apparatus 1 is an apparatus that can charge electricity from the outside and discharge electricity to the outside, and has a substantially rectangular parallelepiped shape in the present example embodiment. For example, the energy storage apparatus 1 is a battery module (assembled battery) used for use in power storage, use in power supply, or the like. More specifically, the energy storage apparatus 1 is used as a battery or the like for driving or starting engines of moving bodies such as cars, motorcycles, watercrafts, ships, snowmobiles, agricultural machines, construction machines, Automatic Guided Vehicles (AGVs), or railway vehicles for electric railways. Examples of the above cars include electric vehicles (EVs), hybrid electric vehicles (HEVs), plug-in hybrid electric vehicles (PHEVs), and fossil fuel (such as gasoline, light oil, and liquefied natural gas) vehicles. Examples of the above railway vehicles for electric railways include trains, monorails, linear motor cars, and hybrid trains including both diesel engines and electric motors. Furthermore, the energy storage apparatus 1 can be also used as a stationary battery or the like used for home use, business use, or the like.

As illustrated in FIGS. 1 and 2, the energy storage apparatus 1 includes an energy storage assembly 20 and an outer case 10 that houses the energy storage assembly 20. The outer case 10 includes a main body 11 that houses the energy storage assembly 20, and an outer lid 12 that closes the main body 11.

The outer case 10 is a container (module case) having a rectangular shape (box shape) that defines the outer case of the energy storage apparatus 1. That is, the outer case 10 fixes the energy storage assembly 20 and the like to predetermined positions and protects these elements from an impact or the like.

The main body 11 is a bottomed rectangular structure that is opened in the X axis positive direction, and this opened portion thereof is an opening 111. The opening 111 has a substantially quadrangular shape in plan view (as viewed in the X axis direction). In addition to the energy storage assembly 20, a plurality of bus bars (not illustrated) and fuses (not illustrated) held by the energy storage assembly 20 are housed in the opening 111 of the main body 11.

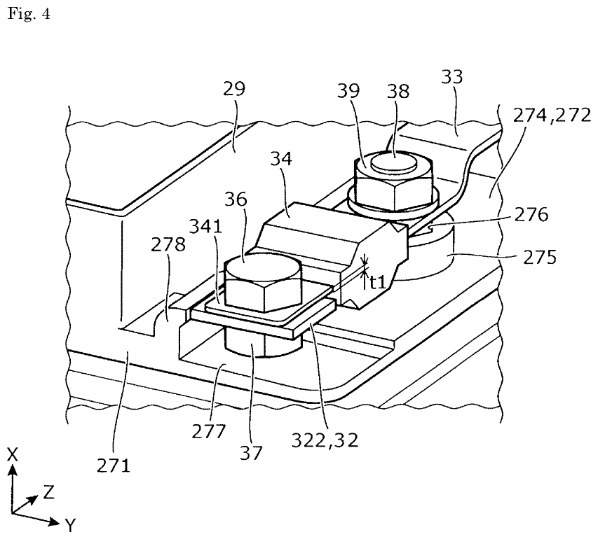

The outer lid 12 closes the opening 111 of the main body 11, and is joined to the main body 11 in a state where the opening 111 of the main body 11 is closed from the X axis positive direction. A circuit board 35 is located at a position meeting the outer lid 12 outside the opening 111. That is, the circuit board 35 is housed between the main body 11 and the outer lid 12. The outer lid 12 includes a pair of (a positive electrode and a negative electrode) external terminals 81. The external terminals 81 are electrically connected with a plurality of energy storage devices 21 included in the energy storage assembly 20 with the bus bars, a fuse 34 (see FIG. 4), and the circuit board 35 interposed therebetween. The energy storage apparatus 1 charges electricity from the outside and discharges electricity to the outside via these external terminals 81. The external terminal 81 may include, for example, a conductor made of a metal such as a copper alloy such as brass, copper, aluminum, or an aluminum alloy.

Here, each bus bar is a plate-shaped structure that electrically connects the external terminals 81 and the energy storage devices 21. Each bus bar includes, for example, a conductor made of a metal such as copper, a copper alloy, aluminum, or an aluminum alloy.

The fuse 34 protects the circuit board 35, the plurality of energy storage devices 21, and the like from a large current equal to or larger than the rated current. When a current equal to or larger than the rated current flows, the fuse is fused to block the flow of the current.

The circuit board 35 includes a plurality of electric components (not illustrated), and the plurality of these electric components define a detection circuit that detects a state (such as a temperature, a voltage, and a current) of each energy storage device 21, a control circuit that controls charging and discharging, and the like. It is sufficient that the circuit board 35 includes at least one of the detection circuit and the control circuit.

The main body 11 and the outer lid 12 of the outer case 10 include, for example, polycarbonate (PC), polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), an ABS resin, an insulator such as a composite material thereof, a metal coated with an insulator, or the like. Thus, the outer case 10 makes the energy storage devices 21 and the like avoid contacting an external metal structure or the like. Note that, as long as a configuration to keep the electric insulation property of the energy storage devices 21 and the like is employed, the outer case 10 may include a conductor made of a metal or the like. The main body 11 and the outer lid 12 may be made of the same material or may include different materials.

The energy storage assembly 20 includes the plurality of energy storage devices 21 and holders 22.

The energy storage device 21 is a secondary battery (battery cell), more specifically, a nonaqueous electrolyte secondary battery such as a lithium ion secondary battery. In the present example embodiment, the energy storage device 21 is a pouch-type energy storage device having a flat shape, and the plurality of (for example, four in the present example embodiment) pouch-type energy storage devices 21 are aligned side by side in the X axis direction. The energy storage devices 21 are not limited to the pouch-type energy storage devices, and may be energy storage devices having a flat rectangular parallelepiped shape (prismatic shape), a columnar shape, an oval columnar shape, an elliptic columnar shape, or the like, and a size and a shape thereof are not limited. The number of the energy storage devices 21 to be aligned is also not particularly limited. The energy storage device 21 is not limited to the nonaqueous electrolyte secondary battery, and may be a secondary battery other than the nonaqueous electrolyte secondary battery or may be a capacitor. The energy storage device 21 may be not a secondary battery, but a primary battery that can use stored electricity even if a user does not charge the electricity. The plurality of energy storage devices 21 are aligned in the X axis direction, and the adjacent energy storage devices 21 may be joined by an adhesive or a double-sided tape, or may not be joined. Details of the energy storage device 21 will be described later.

The holders 22 are portions that hold the plurality of energy storage devices 21. The holder 22 includes a first holder 23 and a second holder 24 that holds the plurality of energy storage devices 21 together with the first holder 23. More specifically, the first holder 23 extends in the X axis negative direction of the plurality of energy storage devices 21, and is joined to the energy storage device 21 disposed at an end portion in the X axis negative direction among the plurality of energy storage devices 21 using an adhesive or a double-sided tape. The second holder 24 extends in the X axis positive direction of the plurality of energy storage devices 21, and is joined to the energy storage device 21 disposed at an end portion in the X axis positive direction among the plurality of energy storage devices 21 using an adhesive or a double-sided tape. Thus, the first holder 23 and the second holder 24 hold the plurality of energy storage devices 21 by sandwiching the plurality of energy storage devices 21 in the X axis direction. Note that it is sufficient that at least one of the first holder 23 and the second holder 24 is joined to the energy storage device 21.

The first holder 23 and the second holder 24 include, for example, polycarbonate (PC), polypropylene (PP), polyethylene (PE), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), an ABS resin, or an insulating resin such as a composite material thereof. Consequently, the first holder 23 and the second holder 24 reduce or prevent the plurality of energy storage devices 21 from conducting with a conductor such as an external metal structure. However, in a case where there is no such necessity, the first holder 23 and the second holder 24 may include a conductor such as a metal.

The first holder 23 includes a flat plate 25 that overlaps the energy storage device 21 at the end portion in the X axis negative direction, and a bus bar support 26 that extends from the flat plate 25 to the X axis positive direction. The bus bar support 26 extends from a corner in a Y axis negative direction and a Z axis negative direction of the flat plate 25 to the X axis positive direction, and supports the unillustrated bus bars. The second holder 24 will be described later.

Next, details of the energy storage device 21 will be described. As illustrated in FIG. 2, the plurality of energy storage devices 21 has the same basic structure, but has partially different outer shapes. More specifically, the odd-numbered energy storage devices 21 in order from the X axis negative direction and the even-numbered energy storage devices 21 in order from the X axis negative direction have the partially different outer shapes. That is, the odd-numbered energy storage devices 21 have the same outer shape, and the even-numbered energy storage devices 21 have the same outer shape.

First, the basic structure of the energy storage device 21 will be described. The energy storage device 21 includes an exterior film 210 and a pair of (a positive electrode and a negative electrode) lead terminals 220, and an electrode assembly (not illustrated), an electrolyte solution (nonaqueous electrolyte: not illustrated), and the like are housed in the exterior film 210. As the electrolyte solution, a type of the electrolyte solution is not particularly limited as long as performance of the energy storage device 21 is not undermined, and a known material can be appropriately used.

The exterior film 210 is a sheet-shaped outer case including a laminate film, and seals and houses the electrode assembly, the electrolyte solution, and the like therein in a decompressed state. The exterior film 210 is formed by stacking two rectangular laminate films in the X axis direction. The two laminate films are bonded (sealed) by thermal welding or the like with the pair of lead terminals 220 interposed therebetween. In the two laminate films, at portions that do not meet the pair of lead terminals 220, the two laminate films are joined (sealed) to each other by thermal welding or the like. The laminate film is a flexible film including a plurality of layers including a metal layer made of aluminum or the like and a resin layer made of polypropylene (PP), polyethylene (PE) or the like, and the resin layer is disposed at a welded portion (seal). Note that the exterior film 210 may be formed by forming the one laminate film in a bag shape and joining end portions of the laminate film to each other by thermal welding.

The lead terminal 220 is a conductive plate-shaped structure (lead plate) that is electrically connected to the electrode assembly, and is positioned while being exposed from the exterior film 210 in a state where the lead terminal 220 penetrates the exterior film 210. In the present example embodiment, the pair of lead terminals 220 aligned side by side in the Z axis direction protrudes from the end portion in the Y axis negative direction of the exterior film 210 to the Y axis negative direction. More specifically, the lead terminal 220 of a positive electrode is a lead terminal electrically connected to a positive electrode plate of the electrode assembly, and the lead terminal 220 of a negative electrode is a lead terminal electrically connected to the negative electrode plate of the electrode assembly. That is, the lead terminal 220 is a metal electrode terminal to lead out electricity stored in the electrode assembly to an external space of the energy storage device 21 and to introduce electricity into an internal space of the energy storage device 21 to store electricity in the electrode assembly. The lead terminal 220 includes aluminum, an aluminum alloy, copper, a copper alloy, or the like.

The electrode assembly is an energy storage element (power generation element) including the positive electrode plate, the negative electrode plate, and a separator stacked on each other. The positive electrode plate includes a positive active material layer provided on a current collector foil including a metal such as aluminum or an aluminum alloy. The negative electrode plate includes a negative active material layer on the current collector foil including a metal such as copper or a copper alloy. As active materials used for the positive active material layer and the negative active material layer, a known material can be appropriately used as long as the material can occlude and release lithium ions. As the separator, a microporous sheet or nonwoven fabric made of a resin can be used. In the present example embodiment, the electrode assembly is formed by stacking plates (the positive electrode plate and the negative electrode plate) in the X axis direction. Note that the electrode assembly may be an electrode assembly of any form such as a winding-type electrode assembly formed by winding the plates (the positive electrode plate and the negative electrode plate), a stacking-type (stack-type) electrode assembly formed by stacking a plurality of plates of flat shapes, or a bellows-type electrode assembly formed by folding the plates in a bellows shape.

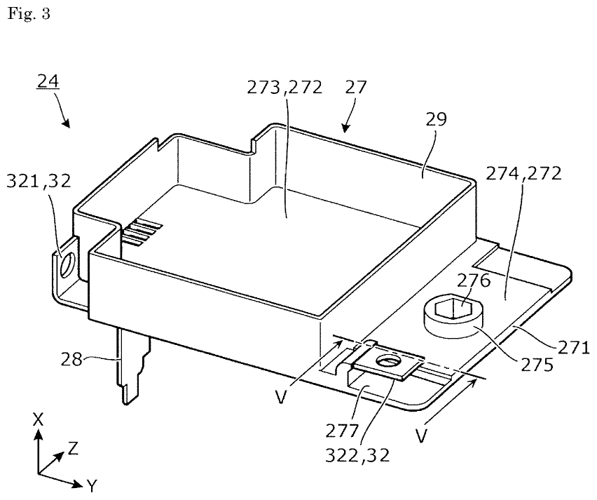

Next, the second holder 24 will be described. FIG. 3 is a perspective view illustrating the second holder 24 according to the present example embodiment. As illustrated in FIGS. 2 and 3, the second holder 24 supports a bus bar 32 that is one of the above-described bus bars, the circuit board 35, and the fuse 34 (see FIG. 4). The second holder 24 is formed by insert-molding the bus bar 32 using the above-described resin. That is, the second holder 24 is an example of a holder to hold the bus bar 32 in a state where a portion of the bus bar 32 is fixed (buried). The second holder 24 is also called an insert-molded body.

More specifically, the second holder 24 includes a holding main body 27 that overlaps the energy storage device 21 at the end portion in the X axis positive direction, and a detection line support 28 that extends from the holding main body 27 to the X axis negative direction.

The detection line support 28 is a portion that supports a plurality of detection lines (not illustrated) connected to the circuit board 35 to detect a state (such as a temperature, a voltage, and a current) of each energy storage device 21. The detection line support 28 extends from the end portion in the Y axis negative direction of the holding main body 27 to the X axis negative direction.

The holding main body 27 supports the bus bar 32, the circuit board 35, and the fuse 34. The holding main body 27 includes a support plate 271 with a plate shape parallel to a ZY plane, and a principal surface in the X axis positive direction of this support plate 271 supports the circuit board 35 and the fuse 34. In a principal surface 272 in the X axis positive direction of the support plate 271, a region that supports the circuit board 35 will be referred to as a first support region 273, and a region closer to the Y axis positive direction than the first support region 273 will be referred to as a second support region 274. The first support region 273 and the second support region 274 are aligned in the Y axis direction, and the first support region 273 is disposed closer to the Y axis negative direction than the second support region 274. The principal surface 272 is provided with a surrounding wall 29 that surrounds the entire circumference of the first support region 273. The surrounding wall 29 does not surround the second support region 274.

The second support region 274 is a region that supports the fuse 34, and a base 275 of a projection shape is disposed at a center in the Z axis direction thereof. A fitting hole 276 into which a head of a bolt 38 (see FIG. 4) is fitted is formed on a distal end surface of this base 275. The bolt 38 is a fixture to fix the fuse 34.

A portion of the bus bar 32 is fixed (buried) at an end portion in the Z axis negative direction of the support plate 271. More specifically, the bus bar 32 is a sheet metal that extends in the Y axis direction, both end portions in the Y axis direction of the bus bar 32 protrude from the support plate 271, and an intermediate portion of the bus bar 32 is fixed (buried) in the support plate 271. The intermediate portion of the bus bar 32 is entirely fixed (buried) to the support plate 271. It is not essential that the intermediate portion of the bus bar 32 is buried. The bus bar 32 may be fixed to the support plate 271 such that the intermediate portion of the bus bar 32 is exposed from the support plate 271.

A one end portion 321 in the Y axis negative direction of the bus bar 32 protrudes from the support plate 271 to the Y axis negative direction, and is bent such that a distal end thereof is directed to the X axis positive direction. The one end portion 321 is connected with the bus bar supported by the bus bar support 26 of the first holder 23.

An other end portion 322 in the Y axis positive direction of the bus bar 32 protrudes from the support plate 271 to the Y axis positive direction, and is connected to the fuse 34. The fuse 34 is an example of a conductor to be joined to the bus bar 32.

FIG. 4 is a perspective view illustrating a connection structure of the other end portion 322 of the bus bar 32 and the fuse 34 according to the present example embodiment. As illustrated in FIG. 4, the fuse 34 extends in the Z axis direction, and leads 341 are provided at both end portions in the Z axis direction. Each lead 341 is a plate body that extends in the Z axis direction along a YZ plane. The lead 341 in the Z axis negative direction of the fuse 34 is connected to the other end portion 322 of the bus bar 32 using a bolt 36 and a nut 37. On the other hand, the lead (not illustrated) in a Z axis positive direction of the fuse 34 is connected to a bus bar 33 connected to the external terminal 81 in a Y axis positive direction using a bolt 38 and a nut 39.

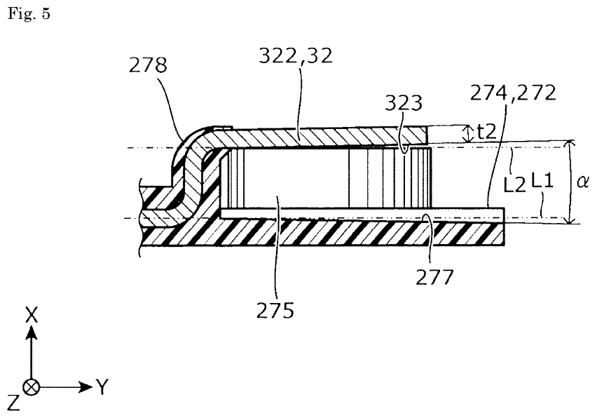

Next, a specific structure of a portion at which the other end portion 322 of the bus bar 32 protrudes in the second support region 274 will be described. FIG. 5 is a partial cross-sectional view of the second support region 274 according to the present example embodiment. FIG. 5 is a cross-sectional view illustrating a cross section that includes line V-V in FIG. 3 and is parallel to an XY plane. FIG. 5 is a cross-sectional view of the portion at which the other end portion 322 of the bus bar 32 protrudes in the second support region 274. FIG. 5 illustrates auxiliary lines L1 and L2 parallel to the Y axis direction.

As illustrated in FIGS. 3 to 5, a step 277 and a support projection 278 are located at an end portion in the Z axis negative direction of the second support region 274.

The step 277 is one surface extending in the X axis negative direction from the principal surface 272. The step 277 is an inclined surface inclined with respect to the YZ plane (see the auxiliary line L1). More specifically, the step 277 is a flat inclined surface that extends toward the X axis negative direction as the step 277 extends toward the Y axis positive direction. If the step 277 inclines in this way, the step 277 may be a curved surface.

The support projection 278 supports the bus bar 32. The support projection 278 protrudes in the X axis positive direction and is curved in the Y axis positive direction. A distal end surface of the support projection 278 is directed to the Y axis positive direction, and the other end portion 322 of the bus bar 32 protrudes from the distal end surface of the support projection 278 toward the Y axis positive direction. A portion of the bus bar 32 closer to the Y axis negative direction than the other end portion 322 of the bus bar 32 is fixed (buried) inside the support projection 278. The portion of the bus bar 32 closer to the Y axis negative direction than the other end portion 322 of the bus bar 32 is bent in accordance with the shape of the support projection 278.

The other end portion 322 of the bus bar 32 is an example of a protrusion that protrudes from the support projection 278 to the Y axis positive direction with such a posture that the other end portion 322 faces the step 277 and is joined to the fuse 34. The other end portion 322 has a flat plate shape and entirely inclines toward the YZ plane. More specifically, the other end portion 322 inclines toward the X axis positive direction as the other end portion 322 extends toward the Y axis positive direction. The surface in the X axis negative direction of the other end portion 322 is a facing surface 323 that faces the step 277. That is, the facing surface 323 also inclines toward the X axis positive direction as the facing surface 323 extends toward the Y axis positive direction. As described above, since the step 277 inclines toward the X axis negative direction as the step 277 extends toward the Y axis positive direction, and the facing surface 323 inclines toward the X axis positive direction as the facing surface 323 extends toward the Y axis positive direction, an interval in the X axis direction between the step 277 and the facing surface 323 widens toward the Y axis positive direction. In other words, the interval in the X axis direction between the step 277 and the facing surface 323 gradually increases toward the Y axis positive direction. An angle α between the step 277 and the facing surface 323 is about 0.5 degrees or more and is preferably about 0.5 degrees or more and three degrees or less, for example. Note that the angle α is measured using a length measuring machine. Particularly when the angle α exceeds three degrees, it is difficult to join the other end portion 322 of the bus bar 32 and the leads 341 of the fuse 34, or the thickness of the support plate 271 of the second holder 24 becomes thin, and a failure such as a decrease in mechanical strength and insulation capability of the second holder 24 occurs. That is, by setting the angle α to about three degrees or less, for example, it is possible to reduce or prevent these failures. Furthermore, a thickness t1 (thickness: see FIG. 4) of the lead 341 of the fuse 34 is smaller than a thickness (thickness) t2 of the other end portion 322 of the bus bar 32. Consequently, the leads 341 deform following inclination of the other end portion 322, so that the leads 341 can be stably joined to the other end portion 322.

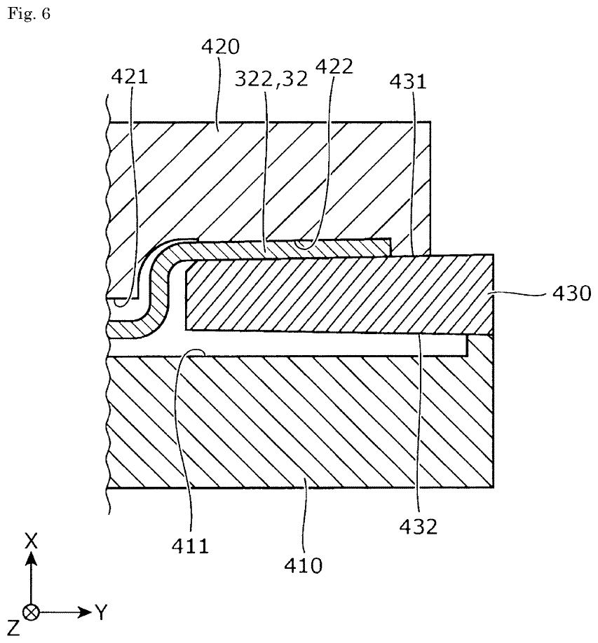

Next, a non-limiting example of a method for manufacturing the energy storage apparatus 1 will be described. More specifically, a time of insert molding of the second holder 24 included in the method for manufacturing the energy storage apparatus 1 will be described. The entire second holder 24 is manufactured by insert molding. However, hereinafter, description will be given by exemplifying a region including the step 277 and the support projection 278 of the second holder 24. FIGS. 6 to 8 are cross-sectional views illustrating one process of the method for manufacturing the energy storage apparatus 1 according to the present example embodiment.

As illustrated in FIG. 6, a plurality of molds 410, 420, and 430 is used at a time of manufacturing of the second holder 24. The mold 410 is a mold in the X axis negative direction of the bus bar 32, and a recess 411 into which a molten resin material flows is formed on a surface in the X axis positive direction thereof. The mold 420 is a mold located in the X axis positive direction of the bus bar 32, and a recess 421 into which the molten resin material flows and a recess 422 into which the other end portion 322 of the bus bar 32 is fitted are continuously formed on the surface in the X axis negative direction of the mold 420. The mold 430 is between the mold 410 and the mold 420 in the X axis direction. The mold 430 has a shape tapered in the Y axis negative direction as viewed in the Z axis direction. More specifically, a surface 431 in the X axis positive direction of the mold 430 inclines toward the X axis negative direction as the surface 431 extends toward the Y axis negative direction. The surface 432 in the X axis negative direction of the mold 430 inclines toward the X axis positive direction as the surface 432 extends toward the Y axis negative direction. The surface 431 of the mold 430 is in close contact with the facing surface 323 of the other end portion 322 of the bus bar 32. The surface 432 of the mold 430 is a surface defining the step 277.

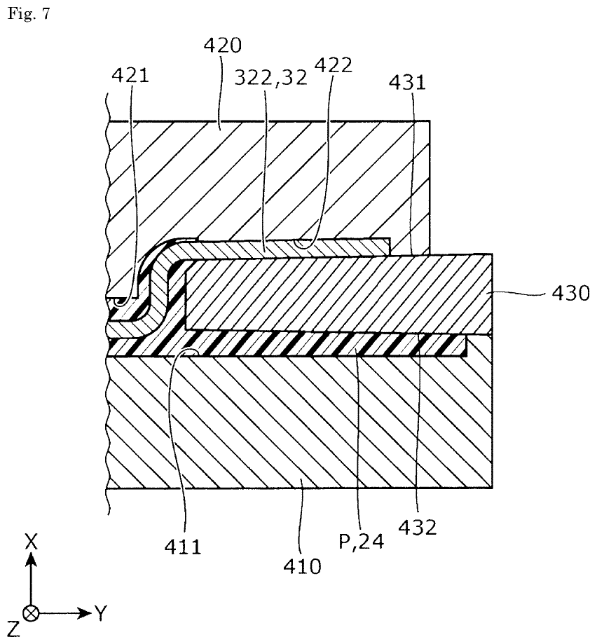

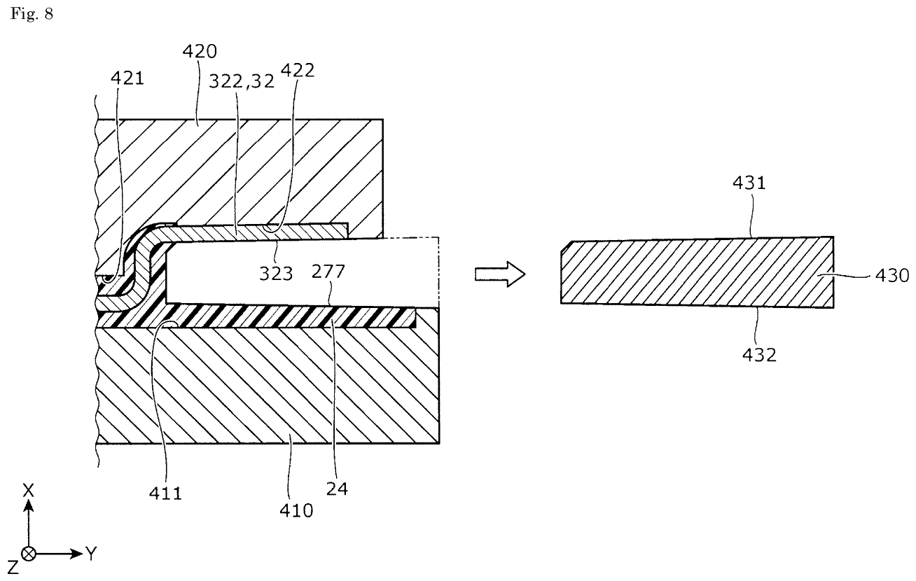

FIG. 7 illustrates a state where a molten resin material P flows into a recess 411 and a recess 421. When the resin material P is cured, the second holder 24 in which the bus bar 32 is insert-molded is formed. Thereafter, as illustrated in FIG. 8, the mold 430 is slid in the Y axis positive direction to be removed from between the other end portion 322 of the bus bar 32 and the step 277. At this time, the interval in the X axis direction between the facing surface 323 of the other end portion 322 and the step 277 widens toward the Y axis positive direction, so that it is possible to smoothly remove the mold 430, and manufacturability is enhanced. The manufacturability refers to easiness of manufacturing.

The interval in the X axis direction between the facing surface 323 and the step 277 widens toward the Y axis positive direction, so that it is possible to reduce friction against the facing surface 323 when the mold 430 is removed in the Y axis positive direction, and reduce or prevent damages on the facing surface 323. Furthermore, it is also possible to reduce or prevent deformation of the other end portion 322 of the bus bar 32. When the other end portion 322 of the bus bar 32 is deformed, the other end portion 322 of the bus bar 32 and the lead 341 of the fuse 34 hardly come into close contact with each other, and the joining property deteriorates. Accordingly, by reducing or preventing deformation of the other end portion 322 of the bus bar 32, it is possible to reduce or prevent a decrease in the joining property of the other end portion 322 of the bus bar 32 and the lead 341 of the fuse 34.

For example, there is also a case where the facing surface 323 of the bus bar 32 is covered with a plating layer. However, if friction at a time of removal is reduced, it is possible to reduce or prevent peeling of the plating layer and the like. Consequently, it is possible to keep the anti-rust capability of the plating layer. If peeling of the plating layer can be reduced or prevented, it is possible to reduce or prevent contamination caused by the peeled plating layer. Furthermore, when the plating layer is peeled off, it is concerned that a contact area between the other end portion 322 of the bus bar 32 and the lead 341 decreases, and an electric resistance rises. However, the plating layer is reduced or prevented from being peeled, so that it is possible to reduce or prevent an increase in electric resistance.

As described above, according to the present example embodiment, at the time of insert molding of the second holder 24 (holder), the mold 430 is located in the interval between the step 277 (one surface) of the second holder 24 and the facing surface 323 of the other end portion 322 (protrusion) of the bus bar 32. The interval between the step 277 and the facing surface 323 widens toward the Y axis positive direction (predetermined direction), so that it is possible to smoothly remove the mold 430 when the mold 430 is removed in the Y axis positive direction. Consequently, it is possible to reduce or prevent damages on the second holder 24 and the other end portion 322 (protrusion), and the joining property of the other end portion 322 (protrusion) and the leads 341 of the fuse 34 improves. That is, it is possible to enhance manufacturability and reliability of the energy storage apparatus 1.

At the time of manufacturing, it is also possible to remove the mold 430 by setting as the predetermined direction a direction (Z axis direction) intersecting the protruding direction (Y axis positive direction) of the other end portion 322 of the bus bar 32. However, in this case, if the other end portion 322 of the bus bar 32 is configured such that the interval between the step 277 and the facing surface 323 widens toward the Z axis direction, the other end portion 322 becomes complicated. By setting the protruding direction (Y axis positive direction) of the other end portion 322 as the predetermined direction as in the present example embodiment, it is possible to prevent the bus bar 32 from becoming complicated.

The entire other end portion 322 inclines toward the Y axis direction, so that it is possible to widen the interval between the step 277 and the facing surface 323 toward the Y axis positive direction with a simple structure.

The angle α between the step 277 and the facing surface 323 is the general draft angle (for example, about 0.5 degrees) or more, so that it is possible to smoothly remove the mold 430.

The thickness t1 of the lead 341 of the fuse 34 is smaller than the thickness t2 of the other end portion 322 of the bus bar 32, so that it is possible to make the fuse 34 more deformable than the other end portion 322. Consequently, even if the other end portion 322 inclines, the fuse 34 can be deformed according to this inclination. Consequently, it is possible to enhance the joining property of the other end portion 322 and the fuse 34.

According to the present example embodiment, at the time of insert molding of the second holder 24 (holder), the mold 430 is located in the interval between the step 277 (one surface) of the second holder 24 and the facing surface 323 of the other end portion 322 (protrusion) of the bus bar 32. The interval between the step 277 and the facing surface 323 widens toward the Y axis positive direction (predetermined direction), so that it is possible to smoothly remove the mold 430 when the mold 430 is removed in the Y axis positive direction. Consequently, it is possible to enhance manufacturability of the energy storage apparatus 1.

Energy storage apparatuses and the like according to some example embodiments of the present invention have been described above. However, the present invention is not limited to the above example embodiments. That is, the example embodiments disclosed herein are illustrative in all respects and are not restrictive, and the scope of the present invention includes all modifications within the meaning and the scope equivalent to the claims.

For example, the above example embodiments have exemplified the case where the facing surface 323 of the other end portion 322 inclines such that the interval between the facing surface 323 of the other end portion 322 and the step 277 widens toward the Y axis positive direction. However, the facing surface 323 of the other end portion 322 may incline such that the interval between the facing surface 323 of the other end portion 322 and the step 277 widens toward the Z axis positive direction (or the Z axis negative direction).

The above example embodiments have exemplified the case where the step 277 inclines toward the X axis negative direction as the step 277 extends toward the Y axis positive direction, and the facing surface 323 inclines toward the X axis positive direction as the facing surface 323 extends toward the Y axis positive direction. However, only one of the step 277 and the facing surface 323 may incline.

The above example embodiments have exemplified the case where the entire other end portion 322 inclines toward the Y axis direction. However, only the facing surface 323 of the other end portion 322 may incline toward the Y axis direction. That is, a surface of the other end portion 322 on an opposite side to the facing surface 323 may be parallel to the Y axis direction.

The above example embodiments have exemplified the case where the angle α formed by the step 277 and the facing surface 323 is about 0.5 degrees or more and about 1.5 degrees or less, for example. However, the angle α may be an angle outside this range.

The above example embodiments have exemplified the case where the thickness t1 of the lead 341 of the fuse 34 is smaller than the thickness t2 of the other end portion 322 of the bus bar 32. However, the thickness t1 may be the thickness t2 or more.

The above example embodiments have exemplified the fuse 34 as the conductor to be connected to the other end portion 322 of the bus bar 32. However, the conductor is not limited thereto. Other examples of the conductor include a bus bar, a voltage sensor, and a temperature sensor.

Configurations constructed by arbitrarily combining the components included in the example embodiments and the modifications thereof are also included in the scope of the present invention.

Example embodiments of the present invention can be applied to energy storage apparatuses or the like each including an energy storage device such as a lithium ion secondary battery.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage apparatus comprising:
an energy storage device;
a bus bar that is electrically connected to the energy storage device;
a holder to hold the bus bar in a state where a portion of the bus bar is fixed; and
a conductor that is joined to the bus bar; wherein
the bus bar includes a protrusion that protrudes with such a posture that the bus bar faces one surface of the holder and is joined to the conductor;
the protrusion includes a facing surface that faces the one surface; and
an interval between the one surface and the facing surface widens toward a predetermined direction.

2. The energy storage apparatus according to claim 1, wherein the predetermined direction is a protruding direction of the protrusion.

3. The energy storage apparatus according to claim 1, wherein the protrusion entirely inclines toward the predetermined direction.

4. The energy storage apparatus according to claim 1, wherein an angle between the facing surface and the one surface is about 0.5 degrees or more.

5. The energy storage apparatus according to claim 1, wherein a thickness of the conductor is smaller than a thickness of the protrusion.

6. A method for manufacturing an energy storage apparatus including an energy storage device, a bus bar that is electrically connected to the energy storage device, and a holder to hold the bus bar in a state where a portion of the bus bar is fixed, the method comprising:
integrating the portion of the bus bar and the holder by insert molding with such a posture that a portion other than the portion of the bus bar is a protrusion that protrudes from the holder; and
removing a mold in an interval toward a predetermined direction, the interval being between one surface of the holder and a facing surface of the protrusion facing the one surface, and widening toward the predetermined direction.
